(19) United States
(12) Patent Application Publication
(10) Pub. No.: US 2026/0097408 A1
(43) Pub. Date: Apr. 9, 2026

(54) UPPER WATER OUTLET SHOWER WITH FILTER AND HAND SHOWER

(71) Applicant: Clement Inc., Covina, CA (US)

(72) Inventors: Shengshen ZHAN, Xiamen (CN); Chunhua WANG, Xiamen (CN); Changzheng NI, Xiamen (CN); Yongqiang YAN, Xiamen (CN)

(73) Assignee: Clement Inc., Covina, CA (US)

(21) Appl. No.: 18/943,273

(22) Filed: Nov. 11, 2024

(30) Foreign Application Priority Data
Oct. 9, 2024 (CN) 2024114009096

(51) Int. Cl. B05B 1/18; E03C 1/04

(52) U.S. Cl. CPC B05B 1/185; E03C 1/0409; E03C 2201/40

(57) ABSTRACT

The present invention provides an upper water outlet shower with a filter and a hand shower, including a curved arm, an overhead shower, and a hand shower. A support arm is connected to the curved arm, and a water passage is provided in the support arm; a shower placement member is mounted on the support arm; a filter assembly is mounted on the support arm and connected to the water passage. The hand shower does not need to be separately mounted on a wall, which simplifies mounting steps. The filter assembly is connected to the water passage to adapt to districts with poor water quality.

### CROSS-REFERENCE TO RELATED APPLICATIONS

The application claims priority to Chinese patent application No. CN2024114009096, filed on Oct. 9, 2024, the entire contents of which are incorporated herein by reference.

### TECHNICAL FIELD

The present invention relates to the field of bath technology, in particular to an upper water outlet shower with a filter and a hand shower.

### BACKGROUND

In current home bath market, there are generally some shortcomings in the design and installation of shower components. In particular, overhead showers and hand showers are often fixed. This means that the overhead shower is directly mounted on the ceiling of a shower area, while the hand shower is fixed to the wall through a wall base. Although this design is simple, there are some inconveniences in actual installation.

Firstly, because the overhead shower and the hand shower need to be fixed separately, the wall and the ceiling need to be drilled with a plurality of holes, which not only increases the difficulty of installation, but also makes the installation more cumbersome and time-consuming. In addition, the holes may damage the wall and the ceiling to some extent, which affects the overall aesthetics.

Secondly, water quality issues are often neglected in the design of existing shower components. In some districts with poor water quality, water may contain many minerals and impurities, which may irritate the skin and even affect health during showering. However, most shower components on the market are not equipped with filtering functions, making it difficult for users to enjoy a clean and comfortable shower experience when the shower components are used in these districts.

### SUMMARY

To solve the above problems, the objective of the present invention is to provide an upper water outlet shower with a filter and a hand shower.

The present invention is achieved by the following method: An upper water outlet shower with a filter and a hand shower includes a curved arm, an overhead shower, and a hand shower, a water inlet channel being provided in the curved arm, where the upper water outlet shower further includes: a support arm, where the support arm is connected to the curved arm, a water passage is provided in the support arm, and the water passage is in communication with the water inlet channel; a shower placement member mounted on the support arm, where the hand shower can be placed on the shower placement member, the overhead shower is movably connected to the support arm, a water inlet port of the overhead shower is in communication with the water passage, and a water inlet port of the hand shower is in communication with the water inlet channel; and a filter assembly mounted on the support arm, where the filter assembly is connected to the water passage, and water in the water passage is filtered by the filter assembly and then enters the overhead shower and/or the hand shower.

Preferably, the filter assembly includes a quick removal base mounted on the support arm and the filter, the filter is mounted on the quick removal base, a filter element is provided in the filter, and the filter is provided with a first inlet and a first outlet; the water passage passes through the quick removal base, a second outlet is provided at a position opposite to the first inlet, a second inlet is provided at a position opposite to the first outlet, and the water in the water passage passes through the filter and then enters the water inlet port(s) of the overhead shower and/or the hand shower.

Preferably, the quick removal base is provided with an insertion hole, a movable clip is provided in the insertion hole, a clamping hole is provided in the clip, a button for pushing the clip to move is provided on one side of the support arm, the side of the filter facing the quick removal base is provided with a clamping portion, the clamping portion can be inserted into the clamping hole, pressing the button can push the clip to move and clamp the clamping portion or release the clamping portion, and the water in the water passage flows through the filter when the clamping portion is inserted into the insertion hole and clamped into the clamping hole.

Preferably, the quick removal base is provided with a limiting portion and a reset member, and the reset member is connected to the clip and used for driving the clip to reset and clamp the clamping portion; the limiting portion cooperates with the clip to limit the clip from separating from the quick removal base.

Preferably, the clip is provided with elastic arms located above or below the clamping hole and on two sides of the clamping portion when the clamping portion is inserted, and the limiting portion includes a first limiting portion; the first limiting portion is fixed on the quick removal base and located between the two elastic arms, first hooks that cooperate with the first limiting portion are symmetrically provided on inner sides of the two elastic arms, the reset member is a spring, and the reset spring is arranged between the first limiting portion and a frame connecting the clip and the button; a clamping groove is provided on a peripheral surface of the clamping portion, and the clip is inserted into the clamping groove on the inner wall at the clamping hole.

Preferably, the limiting portion further includes second limiting portions; one of the second limiting portions is provided on the side wall of the quick removal base opposite to the elastic arm, a second hook is provided on the outer side of the elastic arm opposite to the limiting portion, the hook is located on the side away from the button to limit the movement of the clip during disassembly, an inclined surface protruding inward is further provided on the inner side of the elastic arm, and the inclined surface is located at a position between the first hook and the second hook; the peripheral surface of the clamping portion cooperates with the inner surface of the elastic arm; after the clamping portion is inserted into the insertion hole, the button is pressed to drive the clip to move, the inclined surface contacts and presses against the clamping portion, and the clamping portion expands the elastic arm outward during the movement; when the clip moves to the position of the detachable filter, the second hook hooks the second limiting portion, then the inner wall of the clamping hole is released from the clamping groove, and the filter can be pulled out; after the filter is pulled out, the inclined surface loses the pressing of the peripheral surface of the clamping portion and retracts inward under its force, the second hook is released from the second limiting portion, and the spring can drive the clip to reset until the first hook presses against the first limiting portion.

Preferably, the water passage is provided with a water inlet, the water inlet of the water passage is in communication with an outlet of the water inlet channel, the water passage is provided with a first water outlet and a second water outlet, the water inlet port of the overhead shower is in communication with the first water outlet, and the water inlet port of the hand shower is in communication with the second water outlet.

Preferably, the support arm is hinged with the curved arm by a ball joint, and the overhead shower is hinged with the support arm by a ball joint; the inlet of the water passage of the support arm is located at the hinge between the support arm and the curved arm, and the first water outlet and the water inlet port of the overhead shower are located at the hinge between the overhead shower and the support arm.

Preferably, a switching valve is mounted on the support arm, and the switching valve is connected to the water passage to switch the water in the water passage to flow out of the first water outlet and/or the second water outlet.

Preferably, the shower placement member includes a first magnet fixed to the support arm, a second magnet is provided in the hand shower, and the first magnet and the second magnet can attract each other; a through hole is provided in the middle of a water outlet surface of the shower, and a switching knob of the switching valve can be inserted into the through hole.

The beneficial effects of the present invention are as follows: The present invention provides an upper water outlet shower with a filter and a hand shower. Compared with the prior art, the present invention has at least the following technical effects: 1. The curved arm can be fixed to a wall or a ceiling, and the support arm movable relative to the curved arm is arranged between the overhead shower and the curved arm, so that the angle of the overhead shower can be adjusted when the support arm is adjusted. The setting of the support arm provides enough space to mount the hand shower, and the water passage provided therein facilitates the communication of the water inlet channel with the water inlet ports of the overhead shower and the hand shower. The shower placement member is arranged on the support arm to place the shower, so that both are connected to the support arm and mounted on the curved arm, and the hand shower does not need to be separately mounted on the wall, which simplifies the overall mounting steps. In addition, the filter assembly is connected to the water flow path of the water passage, so that the water flowing in from the water inlet channel is filtered by the filter assembly before entering the overhead shower and/or the hand shower, to adapt to districts with poor water quality. 2. The filter assembly includes the quick removal base mounted on the support arm, and the filter is connected to the quick removal base to quickly connect the filter to the water passage and also to quickly remove and replace the filter. 3. The clip is provided in the quick removal base to clamp the clamping portion of the filter extending into the insertion hole, so as to fix the filter to the quick removal base of the support arm; and the clip can be moved to change the fixation of the filter, so as to achieve quick disassembly and assembly of the filter. 4. The quick removal base is provided with the limiting portion and the reset member, where the limiting portion is used for limiting the clip from separating, and the reset member is used for driving the clip to reset and clamp the filter. 5. The clip is further provided with the elastic arms, the elastic arms are provided with the first hooks, the quick removal base is provided with the first limiting portion between the two elastic arms that cooperates with the mounting of the reset spring, the first hooks cooperate with the first limiting portion to limit the detachment of the clip, and the reset spring cooperates with the first limiting portion to drive the clip to reset and enter the clamping groove to fix the filter. 6. The elastic arm is further provided with the second hook, the quick removal base further has the second limiting portion that cooperates with the second hook, the elastic arm is pushed outward by the clamping portion when the clip is pushed to move, the second hook hooks the second limiting portion, and the clip is released from the clamping groove to limit the movement of the clip and facilitate the removal of the filter. After the filter is removed, the elastic arm loses the pressing of the clamping portion and expands and retracts, the second hook can no longer hook the second limiting portion, and the clip can be reset under the drive of the reset spring. 7. The water passage is provided with one inlet and two outlets, where the water inlet can be shared, and an additional water inlet is not required, which is conducive to saving the production cost. 8. The support arm is hinged with the overhead shower, and the support arm is hinged with the curved arm, which can adjust the shower angle of the overhead shower within a larger angle range. 9. The shower placement member as a magnet facilitates quick fixation of the shower.

### BRIEF DESCRIPTION OF THE DRAWINGS

FIG. 1 is a schematic diagram of separate components of an upper water outlet shower with a filter and a hand shower in the present invention.

FIG. 2 is a schematic structural diagram of the upper water outlet shower with the filter and the hand shower in the present invention.

FIG. 3 is a cross-sectional structural diagram of the upper water outlet shower with the filter and the hand shower in the present invention.

FIG. 4 is a schematic diagram of a support arm and components connected thereto in the present invention.

FIG. 5 is a schematic diagram of separate components of the support arm and a filter assembly in the present invention.

FIG. 6 is a cross-sectional structural diagram of the support arm at a clip in the present invention (in a state of clamping a clamping portion).

FIG. 7 is a cross-sectional structural diagram of the support arm at elastic arms in the present invention.

FIG. 8 is a cross-sectional state diagram of the support arm at the elastic arms when the filter needs to be removed in the present invention.

Explanation of reference numerals: 1. Curved arm; 11. Water inlet channel; 2. Overhead shower; 3. Hand shower; 4. Support arm; 41. Water passage; 411. First water outlet; 412. Second water outlet; 413. Water inlet; 5. Shower placement member; 6. Filter assembly; 61. Quick removal base; 611. Insertion hole; 612. Clip; 6121. Clamping hole; 613. Reset member; 614. Elastic arm; 615. First limiting portion; 616. First hook; 617. Second limiting portion; 618, Second hook; 619. Inclined surface; 62. Filter; 621. First inlet; 622. First outlet; 623. Clamping portion; 624. Clamping groove; 63. Button; 7. Switching valve.

### DETAILED DESCRIPTION OF THE EMBODIMENTS

The present invention will be further explained below in conjunction with the accompanying drawings and specific embodiments.

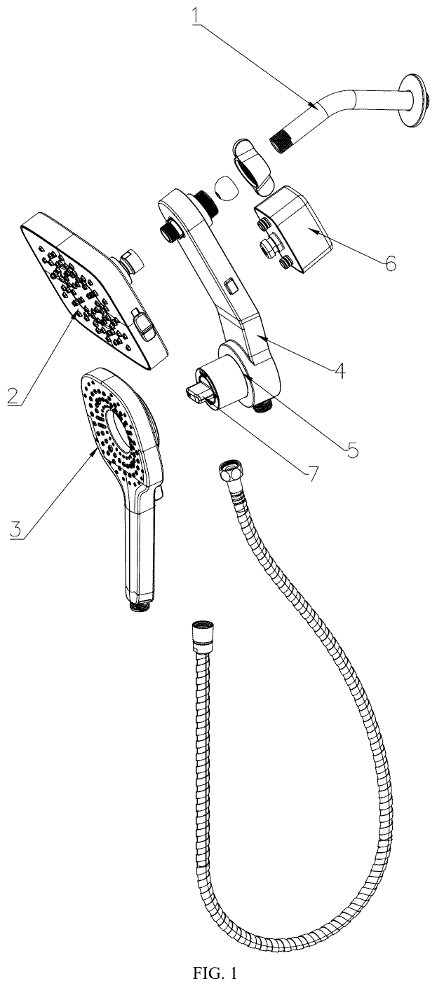

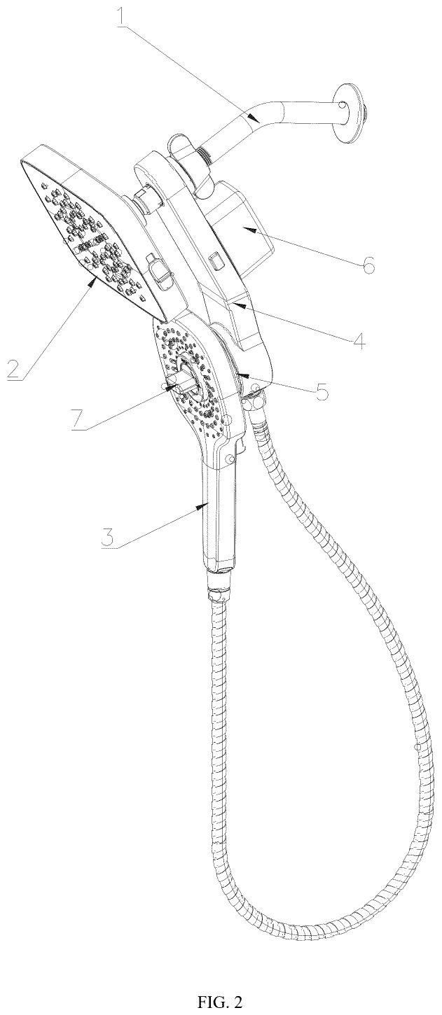

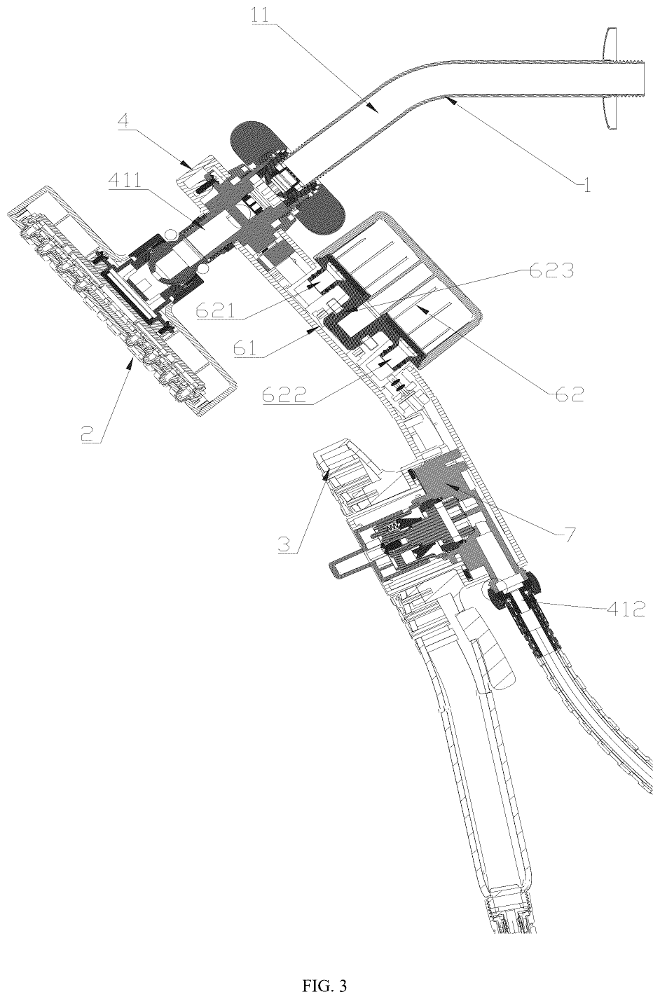

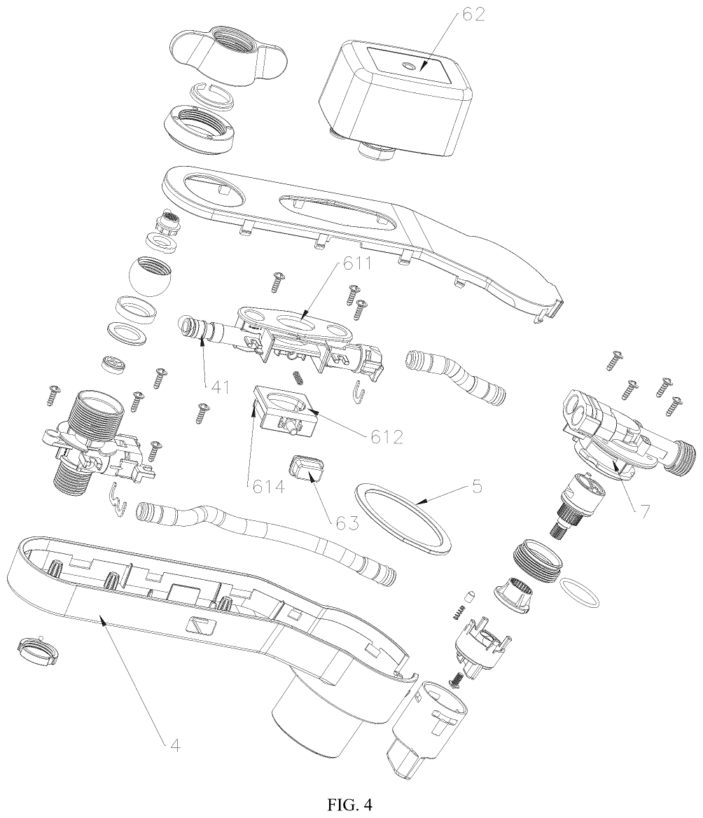

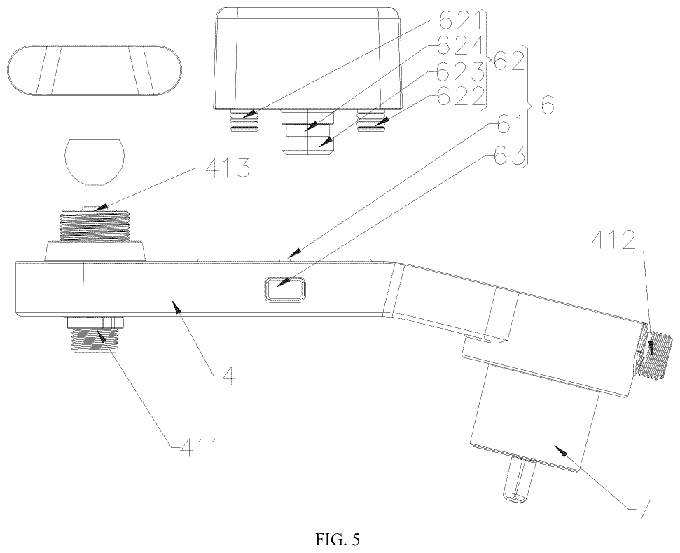

With reference to FIG. 1 to FIG. 8, an upper water outlet shower with a filter 62 and a hand shower 3 includes a curved arm 1, an overhead shower 2, and a hand shower 3, a water inlet channel 11 being provided in the curved arm 1, where the upper water outlet shower further includes: a support arm 4, where the support arm 4 is connected to the curved arm 1, a water passage 41 is provided in the support arm 4, and the water passage 41 is in communication with the water inlet channel 11; a shower placement member 5 mounted on the support arm 4, where the hand shower 3 can be placed on the shower placement member 5, the overhead shower 2 is movably connected to the support arm 4, a water inlet port of the overhead shower 2 is in communication with the water passage 41, and a water inlet port of the hand shower 3 is in communication with the water inlet channel 11; and a filter assembly 6 mounted on the support arm 4, where the filter assembly 6 is connected to the water passage 41, and water in the water passage 41 is filtered by the filter assembly and then enters the overhead shower 2 and/or the hand shower 3. The curved arm 1 can be fixed to a wall or a ceiling, and the support arm 4 movable relative to the curved arm 1 is arranged between the overhead shower 2 and the curved arm 1, so that the angle of the overhead shower 2 can be adjusted when the support arm 4 is adjusted. The setting of the support arm 4 provides enough space to mount the hand shower 3, and the water passage 41 provided therein facilitates the communication of the water inlet channel 11 with the water inlet ports of the overhead shower 2 and the hand shower 3. The shower placement member 5 is arranged on the support arm 4 to place the shower, so that both are connected to the support arm 4 and mounted on the curved arm 1, and the hand shower 3 does not need to be separately mounted on the wall, which simplifies the overall mounting steps. In addition, the filter assembly 6 is connected to the water flow path of the water passage 41, so that the water flowing in from the water inlet channel 11 is filtered by the filter assembly 6 before entering the overhead shower 2 and/or the hand shower 3, to adapt to districts with poor water quality.

With reference to FIG. 1 to FIG. 8, preferably, the filter assembly 6 includes a quick removal base mounted on the support arm 4 and the filter 62, the filter 62 is mounted on the quick removal base, a filter element is provided in the filter 62, and the filter 62 is provided with a first inlet 621 and a first outlet 622; the water passage 41 passes through the quick removal base 61, a second outlet is provided at a position opposite to the first inlet 621, a second inlet is provided at a position opposite to the first outlet 622, and the water in the water passage 41 passes through the filter 62 and then enters the water inlet port(s) of the overhead shower 2 and/or the hand shower 3. The filter assembly 6 includes the quick removal base mounted on the support arm 4, and the filter 62 is connected to the quick removal base to quickly connect the filter 62 to the water passage 41 and also to quickly remove and replace the filter 62.

With reference to FIG. 1 to FIG. 8, preferably, the quick removal base 61 is provided with an insertion hole 611, a movable clip 612 is provided in the insertion hole 611, a clamping hole is provided in the clip 612, a button 63 for pushing the clip 612 to move is provided on one side of the support arm 4, the side of the filter 62 facing the quick removal base 61 is provided with a clamping portion 623, the clamping portion 623 can be inserted into the clamping hole, pressing the button 63 can push the clip 612 to move and clamp the clamping portion 623 or release the clamping portion 623, and the water in the water passage 41 flows through the filter 62 when the clamping portion 623 is inserted into the insertion hole 611 and clamped into the clamping hole. The clip 612 is provided in the quick removal base 61 to clamp the clamping portion 623 of the filter 62 extending into the insertion hole 611, so as to fix the filter 62 to the quick removal base 61 of the support arm 4; and the clip 612 can be moved to change the fixation of the filter 62, so as to achieve quick disassembly and assembly of the filter 62.

With reference to FIG. 1 to FIG. 8, preferably, the quick removal base 61 is provided with a limiting portion and a reset member 613, and the reset member 613 is connected to the clip 612 and used for driving the clip 612 to reset and clamp the clamping portion 623; the limiting portion cooperates with the clip 612 to limit the clip 612 from separating from the quick removal base 61. The quick removal base 61 is provided with the limiting portion and the reset member 613, where the limiting portion is used for limiting the clip 612 from separating, and the reset member 613 is used for driving the clip 612 to reset and clamp the filter 62.

With reference to FIG. 1 to FIG. 8, preferably, the clip 612 is provided with elastic arms 614 located above or below the clamping hole and on two sides of the clamping portion 623 when the clamping portion 623 is inserted, and the limiting portion includes a first limiting portion 615; the first limiting portion 615 is fixed on the quick removal base 61 and located between the two elastic arms 614, first hooks 616 that cooperate with the first limiting portion 615 are symmetrically provided on inner sides of the two elastic arms 614, the reset member 613 is a spring, and the reset spring is arranged between the first limiting portion 615 and a frame connecting the clip 612 and the button 63; a clamping groove 624 is provided on a peripheral surface of the clamping portion 623, and the clip 612 is inserted into the clamping groove 624 on the inner wall at the clamping hole. A transition chamfer is provided on the periphery of the end surface of the clamping portion 623 facing the insertion hole 611, which facilitates pushing the clip 612 away when the clamping portion is inserted into the clamping hole, so that the clamping portion is smoothly inserted into the clamping hole. The clip 612 is further provided with the elastic arms 614, the elastic arms 614 are provided with the first hooks 616, the quick removal base 61 is provided with the first limiting portion 615 between the two elastic arms 614 that cooperates with the mounting of the reset spring, the first hooks 616 cooperate with the first limiting portion 615 to limit the detachment of the clip 612, and the reset spring cooperates with the first limiting portion 615 to drive the clip 612 to reset and enter the clamping groove 624 to fix the filter 62.

With reference to FIG. 1 to FIG. 8, preferably, the limiting portion further includes second limiting portions 617; one of the second limiting portions 617 is provided on the side wall of the quick removal base 61 opposite to the elastic arm 614, a second hook 618 is provided on the outer side of the elastic arm 614 opposite to the limiting portion, the hook is located on the side away from the button 63 to limit the movement of the clip 612 during disassembly, an inclined surface 619 protruding inward is further provided on the inner side of the elastic arm 614, and the inclined surface 619 is located at a position between the first hook 616 and the second hook 618; the peripheral surface of the clamping portion 623 cooperates with the inner surface of the elastic arm 614; after the clamping portion 623 is inserted into the insertion hole 611, the button 63 is pressed to drive the clip 612 to move, the inclined surface 619 contacts and presses against the clamping portion 623, and the clamping portion 623 expands the elastic arm 614 outward during the movement; when the clip 612 moves to the position of the detachable filter 62, the second hook 618 hooks the second limiting portion 617, then the inner wall of the clamping hole is released from the clamping groove 624, and the filter 62 can be pulled out; after the filter 62 is pulled out, the inclined surface 619 loses the pressing of the peripheral surface of the clamping portion 623 and retracts inward under its force, the second hook 618 is released from the second limiting portion 617, and the spring can drive the clip 612 to reset until the first hook 616 presses against the first limiting portion 615. The elastic arm 614 is further provided with the second hook 618, the quick removal base 61 further has the second limiting portion 617 that cooperates with the second hook 618, the elastic arm 614 is pushed outward by the clamping portion 623 when the clip 612 is pushed to move, the second hook 618 hooks the second limiting portion 617, and the clip 612 is released from the clamping groove 624 to limit the movement of the clip 612 and facilitate the removal of the filter 62. After the filter 62 is removed, the elastic arm 614 loses the pressing of the clamping portion 623 and expands and retracts, the second hook 618 can no longer hook the second limiting portion 617, and the clip 612 can be reset under the drive of the reset spring. When the clamping portion 623 is inserted into the insertion hole 611, the first inlet 621 is connected to the second outlet in a sealing manner, and the second inlet is connected to the first outlet 622 in a sealing manner. Preferably, the insertion hole 611 is elliptical, polygonal, or D-shaped, and the corresponding clamping portion 623 is also in this shape, which facilitates positioning and insertion to accurately connect the first inlet 621 and the second outlet and connect the second inlet and the first outlet 622.

With reference to FIG. 1 to FIG. 8, preferably, the water passage 41 is provided with a water inlet 413, the water inlet 413 of the water passage 41 is in communication with an outlet of the water inlet channel 11, the water passage 41 is provided with a first water outlet 411 and a second water outlet 412, the water inlet port of the overhead shower 2 is in communication with the first water outlet 411, and the water inlet port of the hand shower 3 is in communication with the second water outlet 412. The water passage 41 is provided with one inlet and two outlets, where the water inlet 413 can be shared, and an additional water inlet 413 is not required, which is conducive to saving the production cost.

With reference to FIG. 1 to FIG. 4, preferably, the support arm 4 is hinged with the curved arm 1 by a ball joint, and the overhead shower 2 is hinged with the support arm 4 by a ball joint; the inlet of the water passage of the support arm 4 is located at the hinge between the support arm 4 and the curved arm 1, and the first water outlet 411 and the water inlet port of the overhead shower 2 are located at the hinge between the overhead shower 2 and the support arm 4. The support arm 4 is hinged with the overhead shower 2, and the support arm 4 is hinged with the curved arm 1, which can adjust the shower angle of the overhead shower 2 within a larger angle range.

With reference to FIG. 1 to FIG. 3, preferably, a switching valve 7 is mounted on the support arm 4, and the switching valve 7 is connected to the water passage 41 to switch the water in the water passage 41 to flow out of the first water outlet 411 and/or the second water outlet 412. The water can be easily switched to flow out from the overhead shower 2 or the hand shower 3 or the both.

With reference to FIG. 1 to FIG. 4, preferably, the shower placement member 5 includes a first magnet fixed to the support arm 4, a second magnet is provided in the hand shower 3, and the first magnet and the second magnet can attract each other; a through hole is provided in the middle of a water outlet surface of the shower, and a switching knob of the switching valve 7 can be inserted into the through hole. Switching is facilitated, and the positioning and placement of the hand shower 3 are also facilitated. Alternatively, other ordinary shower holder may be used and fixed to the support arm 4, and the switching knob of the switching valve 7 avoids the shower holder.

The present invention has the following working principle:

The curved arm 1 can be fixed to the wall or ceiling, and the support arm 4 movable relative to the curved arm 1 is arranged between the overhead shower 2 and the curved arm 1, so that the angle of the overhead shower 2 can be adjusted when the support arm 4 is adjusted. The setting of the support arm 4 provides enough space to mount the hand shower 3, and the water passage 41 provided therein facilitates the communication of the water inlet channel 11 with the water inlet ports of the overhead shower 2 and the hand shower 3. The shower placement member 5 is arranged on the support arm 4 to place the shower, so that both are connected to the support arm 4 and mounted on the curved arm 1. During mounting, only the curved arm 1 needs to be fixed to the wall, and the hand shower 3 does not need to be separately mounted on the wall, which simplifies the overall mounting steps. In addition, the filter assembly 6 is connected to the water flow path of the water passage 41, so that water flowing in from the water inlet channel 11 is filtered by the filter assembly 6 before entering the overhead shower 2 and/or the hand shower 3, to adapt to districts with poor water quality. Water flows into the water inlet channel 11 of the curved arm 1 and passes through the water passage 41 of the support arm 4, the water in the water passage 41 arrives at the first inlet 621 of the filter 62 via the second outlet, then arrives at the second inlet from the first outlet 622 of the filter 62 and returns to the water passage 41, and the water enters the first water outlet 411 and the second water outlet 412 respectively through the switching valve 7, and enters the overhead shower 2 or the hand shower 3. By turning the switching knob of the switching valve 7, the water can flow out from the first water outlet 411 and the second water outlet 412 respectively, or from both the first water outlet 411 and the second water outlet 412 simultaneously. When the hand shower 3 is used, the hand shower 3 is taken down, and then the switching valve 7 is controlled through the switching knob to switch the second water outlet 412 to release water. After use, the through hole of the hand shower 3 is aligned with the switching knob, and the hand shower 3 is fixed to the support arm 4 by magnetic attraction. When the overhead shower 2 is used, the switching knob is turned to control the second water outlet 412 to release water, and the angle of the overhead shower 2 relative to the support arm 4 or the angle of the support arm 4 relative to the curved arm 1 can be adjusted to adjust the water outlet angle of the overhead shower 2. When water is simultaneously released, the operation is similar.

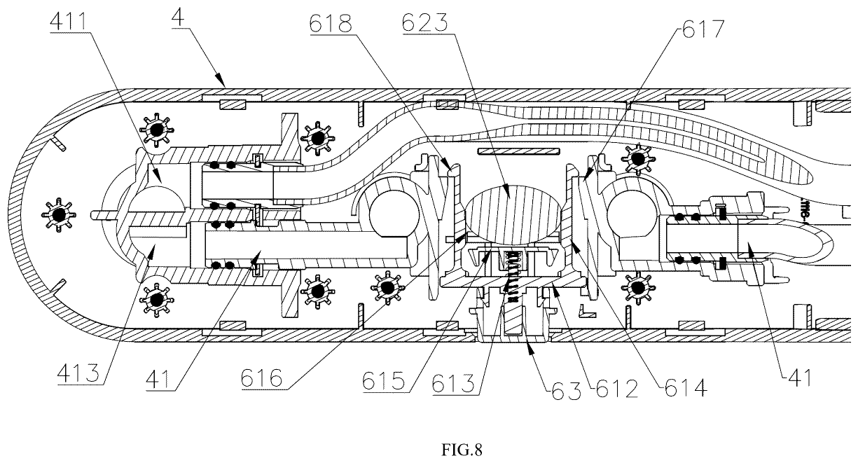

When the filter 62 needs to be replaced, the button 63 on the support arm 4 is pressed to drive the clip 612 to move, the inclined surface 619 contacts and presses against the clamping portion 623, and the clamping portion 623 expands the elastic arm 614 outward during the movement; when the clip 612 moves to the position of the detachable filter 62, the second hook 618 hooks the second limiting portion 617 (shown in FIG. 8), then the inner wall of the clamping hole is released from the clamping groove 624, and the filter 62 can be pulled out; after the filter 62 is pulled out, the inclined surface 619 loses the pressing of the peripheral surface of the clamping portion 623 and retracts inward under its force, the second hook 618 is released from the second limiting portion 617, and the spring can drive the clip 612 to reset until the first hook 616 presses against the first limiting portion 615. Afterwards, the filter 62 is replaced with a new one. The clamping portion 623 of the filter 62 is inserted into the insertion hole 611, the transition chamfer at the head of the clamping portion 623 presses against the inner circumferential surface of the clamping hole 6121 of the clip 612, and the clip 612 moves a small distance (before the second buckle contacts the second limiting portion 617).

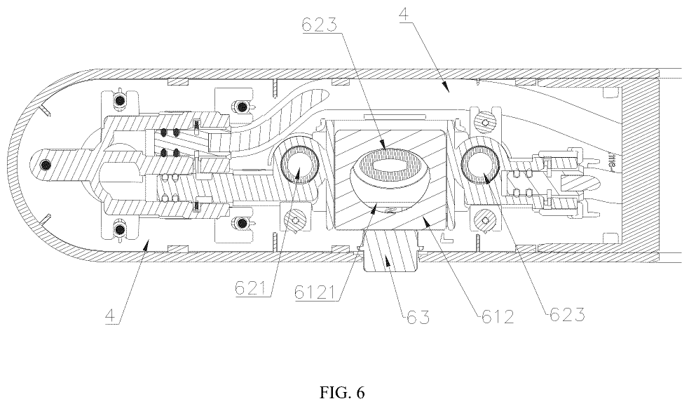

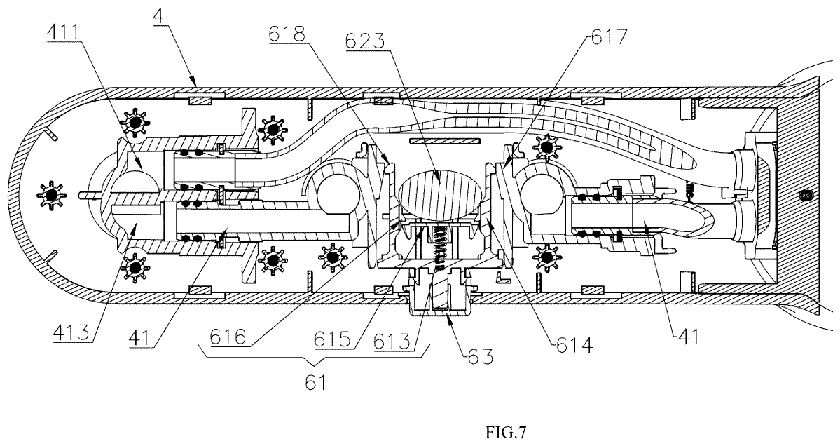

Then, as the clamping portion 623 continues to be inserted, the inner wall of the clamping hole 6121 moves against the circumferential surface of the clamping portion 623 until the position of the clamping groove 624, the inner wall of the clamping hole 6121 is clamped into the clamping groove 624 under the drive of the reset spring (see FIG. 6), and the elastic arm 614 is in the position shown in FIG. 7. In this process, the first inlet 621 is connected to the second outlet in a sealing manner, the second inlet is connected to the first outlet 622 in a sealing manner, and the filter 62 can be easily and quickly replaced.

The following should be noted: Firstly, in the description of the present application, unless otherwise specified and defined, the terms “mounted”, “connected”, and “connection” should be understood in a broad sense, for example, the “connection” may be mechanical or electrical connection, internal communication between two components, or direct connection; the terms “up”, “down”, “left”, “right”, etc. are only used for indicating relative positional relationships; and when the absolute position of a described object changes, the relative positional relationship may change.

Secondly, in the accompanying drawings of the disclosed embodiments of the present invention, only the structures related to the disclosed embodiments are mentioned, and other structures can refer to the usual design; and the same embodiment and different embodiments of the present invention can be combined with each other on a non-conflict basis.

Finally, described above are merely preferred embodiments of the present invention, the protection scope of the present invention is not limited to the above embodiments, and all technical solutions under the concept of the present invention fall within the protection scope of the present invention.

It should be pointed out that those of ordinary skill in the art can make improvements and modifications without departing from the principle of the present invention, and these improvements and modifications shall fall within the protection scope of the present invention.

What is claimed is:

1. An upper water outlet shower with a filter and a hand shower, comprising a curved arm, an overhead shower, and a hand shower, a water inlet channel being provided in the curved arm, further comprising:
a support arm, wherein the support arm is connected to the curved arm, a water passage is provided in the support arm, and the water passage is in communication with the water inlet channel;
a shower placement member mounted on the support arm, wherein the hand shower can be placed on the shower placement member, the overhead shower is movably connected to the support arm, a water inlet port of the overhead shower is in communication with the water passage, and a water inlet port of the hand shower is in communication with the water inlet channel; and
a filter assembly mounted on the support arm, wherein the filter assembly is connected to the water passage, and water in the water passage is filtered by the filter assembly and then enters the overhead shower and/or the hand shower.

2. The upper water outlet shower with the filter and the hand shower according to claim 1, wherein the filter assembly comprises a quick removal base mounted on the support arm and the filter, the filter is mounted on the quick removal base, a filter element is provided in the filter, and the filter is provided with a first inlet and a first outlet; the water passage passes through the quick removal base, a second outlet is provided at a position opposite to the first inlet, a second inlet is provided at a position opposite to the first outlet, and the water in the water passage passes through the filter and then enters the water inlet port(s) of the overhead shower and/or the hand shower.

3. The upper water outlet shower with the filter and the hand shower according to claim 2, wherein the quick removal base is provided with an insertion hole, a movable clip is provided in the insertion hole, a clamping hole is provided in the clip, a button for pushing the clip to move is provided on one side of the support arm, the side of the filter facing the quick removal base is provided with a clamping portion, the clamping portion can be inserted into the clamping hole, pressing the button can push the clip to move and clamp the clamping portion or release the clamping portion, and the water in the water passage flows through the filter when the clamping portion is inserted into the insertion hole and clamped into the clamping hole.

4. The upper water outlet shower with the filter and the hand shower according to claim 3, wherein the quick removal base is provided with a limiting portion and a reset member, and the reset member is connected to the clip and used for driving the clip to reset and clamp the clamping portion; the limiting portion cooperates with the clip to limit the clip from separating from the quick removal base.

5. The upper water outlet shower with the filter and the hand shower according to claim 4, wherein the clip is provided with elastic arms located above or below the clamping hole and on two sides of the clamping portion when the clamping portion is inserted, and the limiting portion comprises a first limiting portion; the first limiting portion is fixed on the quick removal base and located between the two elastic arms, first hooks that cooperate with the first limiting portion are symmetrically provided on inner sides of the two elastic arms, the reset member is a spring, and the reset spring is arranged between the first limiting portion and a frame connecting the clip and the button; a clamping groove is provided on a peripheral surface of the clamping portion, and the clip is inserted into the clamping groove on the inner wall at the clamping hole.

6. The upper water outlet shower with the filter and the hand shower according to claim 5, wherein the limiting portion further comprises second limiting portions; one of the second limiting portions is provided on the side wall of the quick removal base opposite to the elastic arm, a second hook is provided on the outer side of the elastic arm opposite to the limiting portion, the hook is located on the side away from the button to limit the movement of the clip during disassembly, an inclined surface protruding inward is further provided on the inner side of the elastic arm, and the inclined surface is located at a position between the first hook and the second hook; the peripheral surface of the clamping portion cooperates with the inner surface of the elastic arm; after the clamping portion is inserted into the insertion hole, the button is pressed to drive the clip to move, the inclined surface contacts and presses against the clamping portion, and the clamping portion expands the elastic arm outward during the movement; when the clip moves to the position of the detachable filter, the second hook hooks the second limiting portion, then the inner wall of the clamping hole is released from the clamping groove, and the filter can be pulled out; after the filter is pulled out, the inclined surface loses the pressing of the peripheral surface of the clamping portion and retracts inward under its force, the second hook is released from the second limiting portion, and the spring can drive the clip to reset until the first hook presses against the first limiting portion.

7. The upper water outlet shower with the filter and the hand shower according to claim 1, wherein the water passage is provided with a water inlet, the water inlet of the water passage is in communication with an outlet of the water inlet channel, the water passage is provided with a first water outlet and a second water outlet, the water inlet port of the overhead shower is in communication with the first water outlet, and the water inlet port of the hand shower is in communication with the second water outlet.

8. The upper water outlet shower with the filter and the hand shower according to claim 7, wherein the support arm is hinged with the curved arm by a ball joint, and the overhead shower is hinged with the support arm by a ball joint; the inlet of the water passage of the support arm is located at the hinge between the support arm and the curved arm, and the first water outlet and the water inlet port of the overhead shower are located at the hinge between the overhead shower and the support arm.

9. The upper water outlet shower with the filter and the hand shower according to claim 7, wherein a switching valve is mounted on the support arm, and the switching valve is connected to the water passage to switch the water in the water passage to flow out of the first water outlet and/or the second water outlet.

10. The upper water outlet shower with the filter and the hand shower according to claim 9, wherein the shower placement member comprises a first magnet fixed to the support arm, a second magnet is provided in the hand shower, and the first magnet and the second magnet can attract each other; a through hole is provided in the middle of a water outlet surface of the shower, and a switching knob of the switching valve can be inserted into the through hole.
